(19) United States
(12) Patent Application Publication
(10) Pub. No.: US 2008/0291833 A1
(43) Pub. Date: Nov. 27, 2008

(54) Method for buffer control for network device

(76) Inventors: Gustav Gerald Vos, Surrey (CA); William Waung, Burnaby (CA); Peter McConnell, Vancouver (CA)

Correspondence Address: THELEN LLP, P. O. BOX 640640, SAN JOSE, CA, 95164-0640, US

(21) Appl. No.: 11/807,240

(22) Filed: May 25, 2007

(51) Int. Cl. H04J 1/16

(52) U.S. Cl. 370/237

(57) ABSTRACT

Embodiments of the invention provide a queue buffer management method. For one embodiment of the invention, internet protocol data is generated at a data source device. The generated data is communicated to one or more network devices and received at the one or more network devices. Portions of the generated data are selectively deleted based on specified criteria in order to effect improved data flow of the generated data. The specified criteria selected from the group consisting of time since last drop, number of packets since last dropped, packet protocol, packet size and combinations thereof. For one embodiment of the invention, the generated data is communicated via flow controllable interface.

### FIELD

Embodiments of the invention relates to communications networks, more specifically, the present invention relates to methods and systems for controlling a queue buffer of a data communications system.

### BACKGROUND

Conventional methods of queue buffer management include implementing a flow controllable interface (FCI). When a network device is connected to a host that provides a data source through an FCI, the data flow between these devices is often stopped when the queue inside the network device exceeds a specified level. An FCI is implemented to prevent data loss in the event that network device's queue were to ever overflow. When the data flow between the network device and the host is stopped, the network layer in the host will be required to queue the data as the flow control above the network layer is controlled by the transport layer. Depending on the transport layer (TCP, UDP, etc.) and transport parameters (such as rwin), often excessive queuing will occur in the host.

Such systems have disadvantages associated with excessive queuing. One disadvantage is that excessive queuing will cause an increase in the time required for data to traverse a link from the data source to the data destination (e.g., network device) and back to the data source. This time is known and the round trip time (RTT) for the channel. The increase in RTT is equal to the amount of queued data times the maximum output rate of the network device.

FIG. 1 illustrates a system implementing a FCI in accordance with the prior art and the disadvantages thereof. For TCP data, the root cause of the increase in RTT and the decrease in throughput is that the Uplink's receive window size is being set too large by the far end server. The increase in RTT is caused by excessive queuing in the uplink's data path below the TCP protocol where the multiple TCP sessions are multiplexed into one stream (For UDP data, the excessive queuing will occur anytime the UDP streams data rate exceeds the network devices output rate.)

The throughput degradation for a TCP stream occurs due to the following data communications processes of a typical TCP FCI. The application sends data to the network device faster than it can be sent out so data has to get queued along with the DL acknowledgements, as shown in FIG. 1. The queued data causes an increase in the RTT which causes delay in the DL TCP acknowledgements to the far end data source (not shown). The lack of timely TCP acknowledgements causes the far end data source to decrease the data transmission rate.

### SUMMARY OF THE INVENTION

Embodiments of the invention provide a method for queue buffer management. For one embodiment of the invention, internet protocol data is generated at a data source device. The generated data is communicated to one or more network devices and received at the one or more network devices. Portions of the generated data are selectively dropped based on specified criteria in order to effect improved data flow of the generated data. The specified criteria selected from the group consisting of time since last drop, number of packets since last dropped, packet protocol, packet size and combinations thereof. For one embodiment of the invention, the generated data is communicated via flow controllable interface.

Other advantages and embodiments will be described in the detailed description.

### BRIEF DESCRIPTION OF THE DRAWINGS

The invention may be best understood by referring to the following description and accompanying drawings that are used to illustrate embodiments of the invention. In the drawings:

FIG. 1 illustrates a system implementing a FCI in accordance with the prior art and the disadvantages thereof;

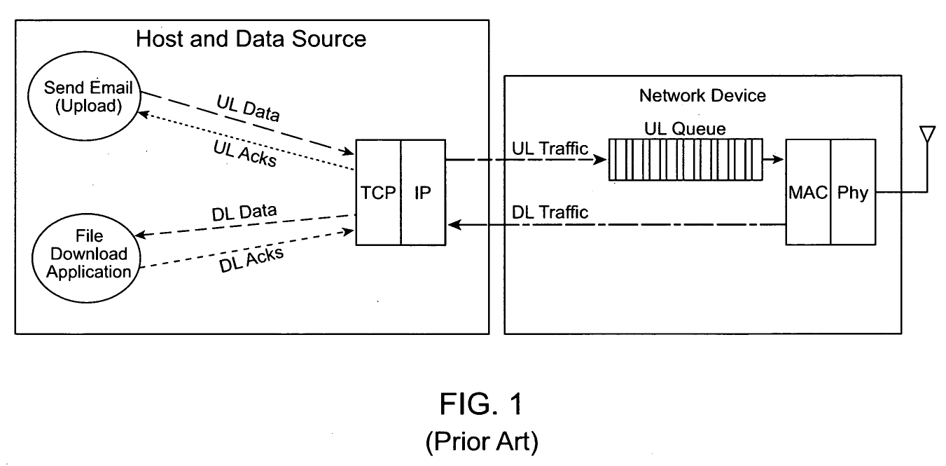

FIG. 2 illustrates a data communications system in accordance with one embodiment of the invention;

FIG. 3 illustrates a process to effect queue buffer management of a data communications system in accordance with one embodiment of the invention;

FIG. 4 illustrates a process flow diagram of a method for queue buffer management in accordance with one embodiment of the invention; and

FIG. 5 illustrates a functional block diagram of a digital processing system that may be used to communicate data in accordance with one embodiment of the invention.

### DETAILED DESCRIPTION

A method and system for queue buffer management in which received data is selectively deleted based upon specified criteria in order to improve data flow. For various embodiments of the invention in which the system implements a FCI, the specified criteria may include one or more of the following in various combinations: queue depth, filtered queue depth, time since last dropped data, amount of received data since last dropped data, and, for systems implementing packet-based data communications, packet size and packet protocol. For embodiments of the invention implemented within a non-flow controllable environment, the specified criteria may include one or more of the following in various combinations: time since last dropped data, amount of received data since last dropped data, and, for systems implementing packet-based data communications, packet size and packet protocol.

Those of ordinary skill in the art will realize that the following detailed description of various embodiments of the invention is illustrative only and is not intended to be in any way limiting. Other embodiments of the invention will readily suggest themselves to such skilled persons having the benefit of this disclosure. It will be apparent to one skilled in the art that these specific details may not be required to practice embodiments of the invention. In other instances, well-known elements and devices are shown in block diagram form to avoid obscuring the invention. In the following description of the embodiments, substantially the same parts are denoted by the same reference numerals.

In the interest of clarity, not all of the features of the implementations described herein are shown and described. It will, of course, be appreciated that in the development of any such actual implementation, numerous implementation-specific devices must be made in order to achieve the developer's specific goals, wherein these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with an embodiment of the invention, the components, process steps, and/or data structures may be implemented using various types of operating systems, computing platforms, computer programs, and/or general purpose machines. In addition, those of ordinary skill in the art will recognize that devices of a less general purpose nature may also be used without departing from the scope and spirit of the inventive concepts disclosed herein.

While particular embodiments of the invention have been shown and described, it will now be apparent to those skilled in the art having the benefit of this disclosure that many more modifications than mentioned above are possible without departing from the inventive concepts disclosed herein. Moreover, inventive aspects lie in less than all features of a single disclosed embodiment. Thus, the claims following the Detailed Description are hereby expressly incorporated into this Detailed Description, with each claim standing on its own as a separate embodiment of this invention.

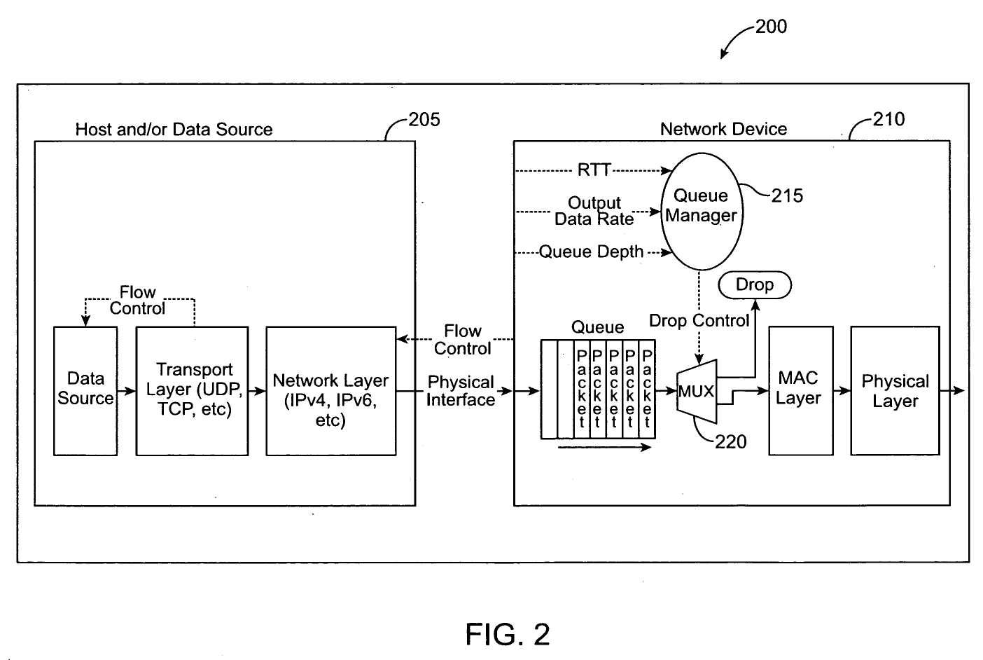

FIG. 2 illustrates a data communications system in accordance with one embodiment of the invention. System 200, shown in FIG. 2, includes a data source device 205 that generates data (e.g., internet protocol data). The generated data is communicated to one or more network devices, shown, for example as network device 210, which receives the data. The network device is communicatively coupled to the data source device through wired or wireless communication means as known in the art. For one embodiment of the invention, the network device 210 is communicatively coupled to the data source device 205 through an FCI such as, for example, USB, PCMCIA, ExpressCard, PCI Express Mini, or Serial.

Network device 210 includes a queue management functionality 215 that determines whether or not to delete a portion (e.g., drop a packet) of the received data based upon specified criteria, shown for example as criteria RTT, output data rate, and queue depth.

The queue management functionality 215 is coupled to a multiplexer 220 through which the determination to drop or delete data is effected as shown in FIG. 2.

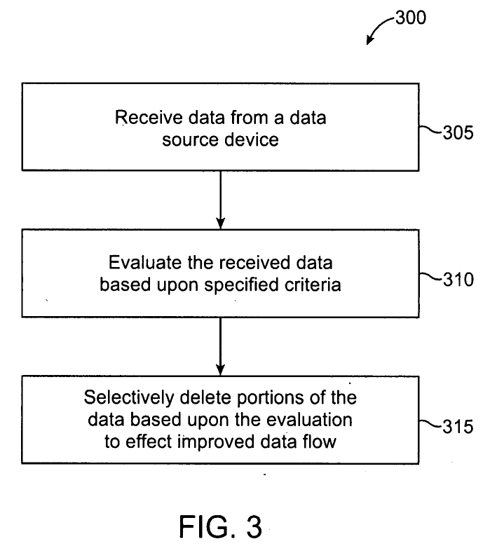

FIG. 3 illustrates a process to effect queue buffer management of a data communications system in accordance with one embodiment of the invention. Alternative embodiments of the invention provide queue management methods which solve the excessive queuing issue while still maintaining maximum network device output rate.

Process 300, shown in FIG. 3, begins at operation 305 in which data is received from a data source device to a network device implementing a queue buffer management scheme.

At operation 310 the received data is evaluated based upon specified criteria. The specified criteria may include static and dynamic parameters of the data communications system. Dynamic parameters may include, for example, congestion threshold, minimum time interval, minimum drop packet size, and data protocol, which may be a function of, for example, the output data rate, RTT, and queue depth.

For one embodiment of the invention one or more of the specified criteria may be dynamically determined prior to or during the data communication. For various alternative embodiments of the invention, one or more of the specified criteria have a corresponding value (e.g., bytes, seconds, etc.) that may be dynamically determined prior to or during the data communication.

At operation 315 portions of the data are selectively deleted based on the evaluation in order to improve data flow of the data communications system.

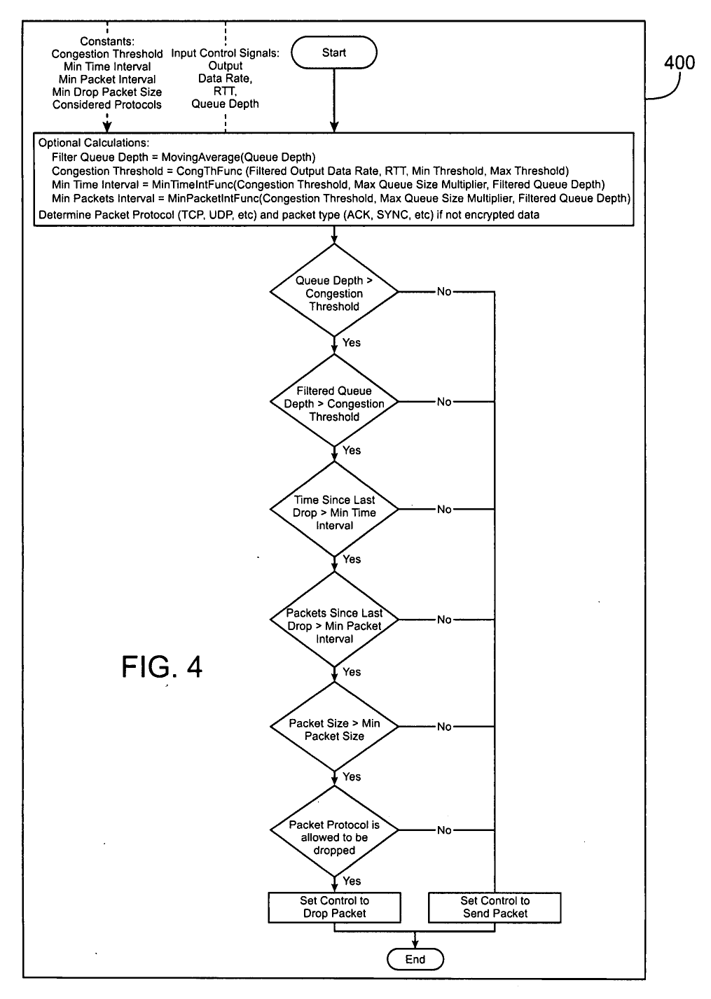

FIG. 4 illustrates a process flow diagram of a method for queue buffer management in accordance with one embodiment of the invention.

As shown in FIG. 4, for one embodiment of the invention, the queue management process uses input signals: estimated channel RTT, estimated output data rate, and the current queue depth. The process determines whether a portion of data (e.g., a packet) in the queue should be sent to the next layer of the protocol.

For one embodiment of the invention, the queue management method is driven off the TCP congestion control mechanism, which lowers the congestion window and thus the amount of in-flight data or unacknowledged data at the sign of congestions. The lower the in-flight data, the slower the data source can send data. There are two methods that can be deployed to indicate congestion to the sending TCP stack: a dropped packet or the setting of explicit congestion notification flags in the TCP header. In its very basic form, the queue manager will monitor the queue depth. When the queue depth exceeds some threshold (i.e., the congestion threshold in this document), it triggers the TCP congestion control mechanism by dropping a packet or triggering the explicit congestion notification. The queue depth is only one of many factors the queue management system needs to consider before dropping a packet.

For one embodiment of the invention, input to the queue management system is a set of real-time control signals and tunable constants. The following is a list of the basic tunable constants used to control the queue management system for variable system data rates and RTTs.

As shown in FIG. 4, the method in accordance with one embodiment of the invention may use one or more tunable parameters including the following.

Congestion Threshold: A packet is dropped when the average queue length and the current queue length exceed this threshold.

Min Time Interval: A packet is only consider for dropping after this amount of time has elapse since the last dropped packet.

Min Packet Interval: A packet is only consider for dropping after this many packets have been sent since the last dropped packet.

Min Drop Packet size: This constant is the minimum size a packet has to be to be considered for dropping.

Transport Protocols Consider for Drop: This contains a list of transport protocols that are consider in determining to delete (drop) data. Some protocols may be considered such as TCP or UDP. Other protocols such as ICMP, RTP, etc. may not be considered for dropping.

Included as Appendix A are example methods for implementing these criteria and other consideration useful in determining whether to delete information to effect queue buffer management and improve data flow.

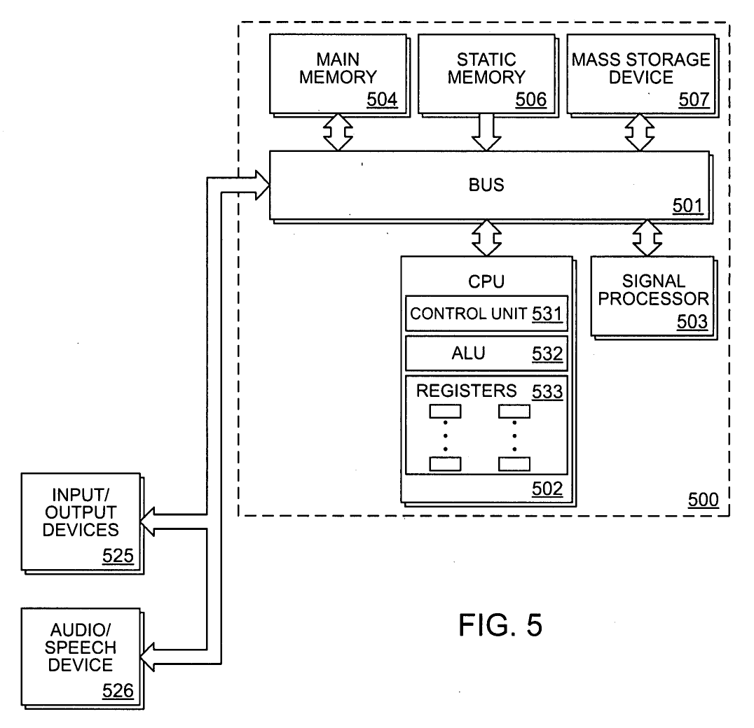

Referring again to FIG. 2, data source device 205 and network device 210 may any of a variety of digital processing system (DPSs) as will be appreciated by those of skill in the art. FIG. 5 illustrates a functional block diagram of a digital processing system that may be used to communicate data in accordance with one embodiment of the invention. The components of processing system 500, shown in FIG. 5 are exemplary in which one or more components may be omitted or added. For example, one or more memory devices may be utilized for processing system 500.

Referring to FIG. 5, processing system 500 includes a central processing unit 502 and a signal processor 503 coupled to a main memory 504, static memory 506, and mass storage device 507 via bus 501. In accordance with an embodiment of the invention, main memory 504 may store a selective communication application, while mass storage devise 507 may store various digital content as discussed above. Processing system 500 may also be coupled to input/output (I/O) devices 525, and audio/speech device 526 via bus 501. Bus 501 is a standard system bus for communicating information and signals. CPU 502 and signal processor 503 are processing units for processing system 500. CPU 502 or signal processor 503 or both may be used to process information and/or signals for processing system 500. CPU 502 includes a control unit 531, an arithmetic logic unit (ALU) 532, and several registers 533, which are used to process information and signals. Signal processor 503 may also include similar components as CPU 502.

Main memory 504 may be, e.g., a random access memory (RAM) or some other dynamic storage device, for storing information or instructions (program code), which are used by CPU 502 or signal processor 503. Main memory 504 may store temporary variables or other intermediate information during execution of instructions by CPU 502 or signal processor 503. Static memory 506, may be, e.g., a read only memory (ROM) and/or other static storage devices, for storing information or instructions, which may also be used by CPU 502 or signal processor 503. Mass storage device 507 may be, e.g., a hard disk drive or optical disk drive, for storing information or instructions for processing system 500.

### General Matters

Embodiments of the invention provide methods and systems to effect queue management in a data communications system. For one embodiment of the invention, internet protocol data is generated at a data source device. The generated data is communicated to one or more network devices and received at the one or more network devices. Portions of the generated data are selectively deleted based on specified criteria in order to effect improved data flow of the generated data. For one embodiment of the invention, the generated data is communicated via flow controllable interface.

Alternative embodiments of the invention provide queue management methods which solve the excessive queuing issue while still maintaining maximum network device output rate.

Embodiments of the invention include various operations such as communicating, buffering, and processing data. For various embodiments, one or more operations described may be added or deleted. For example, there are several alternative methods that the network device could use to obtain the estimated RTT and estimated output data rate. The RTT could be measured by examining the time it takes to acknowledge data that has been sent. If the data is encrypted as it enters the network device, calculated RTT in this manner will not be possible. Alternately, the RTT can be estimated if the network device could generate a low rate of pings to either a known static IP address or IP addresses found in the queue. Also, a fixed worst case RTT or a generalized RTT estimate can be made based on the physical layer's channel conditions. The output data rate could be calculated by measuring the rate at which data is exiting the queue and/or could be determined by the physical layer channel access grants.

The operations of the invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software. Embodiments of the invention may be provided as a computer program product that may include a machine-readable medium having stored thereon instructions, which may be used to program a computer (or other electronic devices) to perform a process according to the invention. The machine-readable medium may include, but is not limited to, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection).

Further, though described for various embodiments in specific context, embodiments of the invention are applicable to a variety of single channel or multi-channel data transfer systems employing multiple data standards.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving internet protocol data at the one or more network devices, the internet protocol data generated at a data source device and communicated to the one or more network devices; and
selectively deleting portions of the data based on specified criteria to effect improved data flow of the internet protocol data, the specified criteria selected from the group consisting of time since last drop, number of packets since last dropped, packet protocol, packet size and combinations thereof.

2. The method of claim 1 wherein the one or more of the specified criteria are dynamically determined.

3. The method of claim 1 wherein one or more specified criteria have a corresponding value that is dynamically determined.

4. The method of claim 1 wherein the generated data is encrypted and the specified criteria includes packet size.

5. A method comprising:
receiving internet protocol data, communicated via a flow controllable interface, at the one or more network devices, the internet protocol data generated at a data source device and communicated to the one or more network devices; and
selectively deleting portions of the data based on specified criteria to effect improved data flow of the internet protocol data.

6. The method of claim 5 wherein the one or more of the specified criteria are dynamically determined.

7. The method of claim 5 wherein one or more specified criteria have a corresponding value that is dynamically determined.

8. The method of claim 5 wherein the generated data is encrypted and the specified criteria includes packet size.

9. An apparatus comprising:
a network device communicatively coupled to a data source device, the network device configured to receive internet protocol data generated at the data source device and selectively delete portions of the data based on specified criteria to effect improved data flow of the internet protocol data the specified criteria selected from the group consisting of time since last drop, number of packets since last dropped, packet protocol, packet size and combinations thereof.

10. The apparatus of claim 9 wherein the one or more of the specified criteria are dynamically determined.

11. The apparatus of the claim 9 wherein one or more specified criteria have a corresponding value that is dynamically determined.

12. The apparatus of claim 9 wherein the generated data is encrypted and the specified criteria includes packet size.

13. An apparatus comprising:
a network device communicatively coupled to a data source device, the network device configured to receive internet protocol data generated at the data source device, the internet protocol data communicated via a flow controllable interface, and selectively delete portions of the data based on specified criteria to effect improved data flow of the internet protocol data.

14. The apparatus of claim 13 wherein the one or more of the specified criteria are dynamically determined.

15. The apparatus of the claim 13 wherein one or more specified criteria have a corresponding value that is dynamically determined.

16. The apparatus of claim 13 wherein the generated data is encrypted and the specified criteria includes packet size.

17. A machine-readable medium that provides executable instructions, which when executed by a processor, cause the processor to perform a method, the method comprising:
receiving internet protocol data at the one or more network devices, the internet protocol data generated at a data source device and communicated to the one or more network device; and
selectively deleting portions of the data based on specified criteria to effect improved data flow of the internet protocol data the specified criteria selected from the group consisting of time since last drop, number of packets since last dropped, packet protocol, packet size and combinations thereof.

18. The machine-readable medium of claim 17 wherein the one or more of the specified criteria are dynamically determined.

19. The machine-readable medium of claim 17 wherein one or more specified criteria have a corresponding value that is dynamically determined.

20. The machine-readable medium of claim 17 wherein the generated data is encrypted and the specified criteria includes packet size.

21. A machine-readable medium that provides executable instructions, which when executed by a processor, cause the processor to perform a method, the method comprising:
receiving internet protocol data, communicated via a flow controllable interface, at the one or more network devices, the internet protocol data generated at a data source device and communicated to the one or more network devices; and
selectively deleting portions of the data based on specified criteria to effect improved data flow of the internet protocol data.

22. The machine-readable medium of claim 21 wherein the one or more of the specified criteria are dynamically determined.

23. The machine-readable medium of claim 21 wherein one or more specified criteria have a corresponding value that is dynamically determined.

24. The machine-readable medium of claim 21 wherein the generated data is encrypted and the specified criteria includes packet size.
